(19) United States
(12) Patent Application Publication
(10) Pub. No.: US 2011/0268165 A1
(43) Pub. Date: Nov. 3, 2011

(54) CABLE MODEM AND METHOD OF SUPPORTING VARIOUS PACKET CABLE PROTOCOLS

(75) Inventor: Yew-Min LO, Tu-Cheng (TW)

(73) Assignee: HON HAI PRECISION INDUSTRY CO., LTD., Tu-Cheng (TW)

(21) Appl. No.: 12/846,797

(22) Filed: Jul. 29, 2010

(30) Foreign Application Priority Data
Apr. 28, 2010 (CN) 201010158515.6

(51) Int. Cl. H04L 5/16; G06F 15/177

(52) U.S. Cl. 375/222; 709/220

(57) ABSTRACT

A cable modem communicates with a plurality of packet cable dynamic host configuration protocol (DHCP) servers and a terminal DHCP server. Each packet cable DHCP server corresponds to one packet cable protocol. The cable modem broadcasts a DHCP discover packet with one packet cable protocol to the packet cable DHCP servers and the terminal DHCP server, and receives a DHCP offer packet from one of the packet cable DHCP servers and the terminal DHCP server. The cable modem changes the one packet cable protocol to another packet cable protocol to make the communication module receive a compliant DHCP offer packet upon the condition that the received DHCP offer packet is incompliant with the one packet cable protocol.

### BACKGROUND

1. Technical Field

Embodiments of the present disclosure relate to modems, and more particularly to a cable modem and a method of supporting various packet cable protocols.

2. Description of Related Art

Packet cable is an important protocol of cable modems to provide multimedia service over Internet protocol, such as voice over Internet protocol (VoIP) service. There are various packet cable protocols, such as packet cable version 1.0, packet cable version 1.5, and packet cable version 2.0. That is, there are packet cable 1.X indicating 1.0 and 1.5 and packet cable 2.0 to provide VoIP service in cable modems.

Media gateway control protocol (MGCP) and session initiation protocol (SIP) are two important protocols for VoIP service. However, MGCP and SIP respectively correspond to different packet cable protocols, and MGCP and SIP are incompatible. In detail, MGCP corresponds to packet cable 1.X and cannot correspond to packet cable 2.0. SIP corresponds to packet cable 2.0 and cannot correspond to packet cable 1.X.

Generally, packet cable protocol of a cable modem is either packet cable 2.0 or packet cable 1.X, which are determined by protocol of a communication network of the cable modem. In detail, if the communication network uses MGCP to provide VoIP service, the cable modem must use packet cable 1.X. If the communication network uses SIP to provide VoIP service, the cable modem must use packet cable 2.0. Therefore, when the protocol of the communication network is changed, the cable modem is required to be discarded and a new cable modem is required, which causes inconvenience and high cost.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of environment of one embodiment of a cable modem of the present disclosure;

FIG. 2 is a schematic diagram of functional modules of one embodiment of a cable modem of the present disclosure;

FIG. 3 is a flowchart of a method of supporting various of packet cable protocol of one embodiment of the present disclosure;

FIG. 4 is a schematic diagram of one embodiment of the method of FIG. 3 of the present disclosure; and

FIG. 5 is a schematic diagram of another embodiment of the method of FIG. 3 of the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

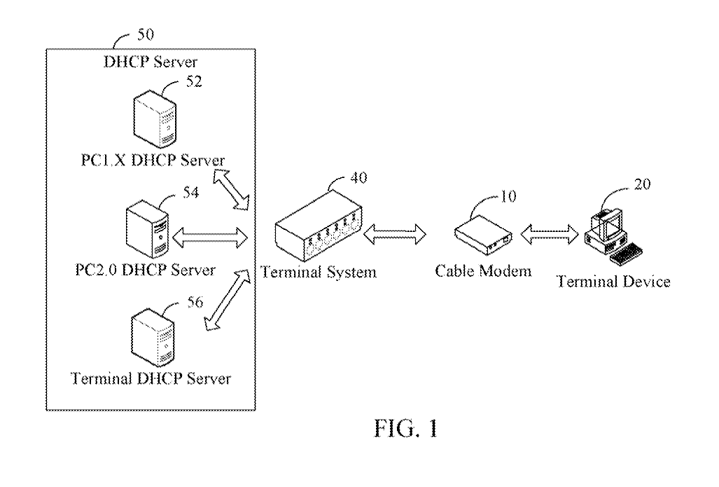

FIG. 1 is a schematic diagram of environment of one embodiment of a cable modem 10 of the present disclosure. The cable modem 10 boots and obtains Internet protocol (IP) address from a dynamic host configuration protocol (DHCP) server 50 by way of a terminal system 40. After that, the cable modem 10 provides VoIP services for the terminal device 20. In one embodiment, the terminal system 40 may be a cable modem terminal system (CMTS) or a center official (CO) accessing device, such as a CO router. The terminal device 20 may be a computer or an IP telephone, for example.

In one embodiment, the cable modem 10 supports at least two packet cable protocols, one is packet cable (PC) 1.X, the other is PC2.0. PC1.X indicates PC1.0 or PC1.5. It is noted that the cable modem 10 may support all packet cable protocols along with various technology improvements. In the present disclosure, the following detailed description takes PC1.X and PC2.0 for example.

The cable modem 10 works with a default PC protocol. In one embodiment, the default PC protocol may be PC1.X or PC2.0 and is determined by a manufacture of the cable modem 10. A service provider sets a PC protocol, such as PC1.X or PC2.0, for all cable modems connected to the DHCP server 50. If the default PC protocol of the cable modem 10 is the same as the PC protocol set by the service provider, the cable modem 10 can obtain an available IP address from the DHCP server 50.

In the contrary, if the default PC protocol of the cable modem 10 is the different from the PC protocol set by the service provider, the cable modem 10 can not obtain the available IP address from the DHCP server 50. The cable modem 10 in the present disclosure can automatically select one of the PC protocols according to the PC protocol set by the service provider. Therefore, whichever PC protocol the service provider set, the cable modem 10 can obtain the available IP address from the DHCP server 50.

The DHCP server 50 includes several PC DHCP servers for providing IP address distribution service for cable modems, such as a PC1.X DHCP server 52 and a PC2.0 DHCP server 54. The PC1.X DHCP server 52 indicates a DHCP server supporting PC1.X and all the cable modems whose PC protocols are set as PC1.X by the service provider are served by the PC1.X DHCP server 52. The PC2.0 DHCP server 54 indicates a DHCP server supporting PC2.0 and all the cable modems whose PC protocols are set as PC2.0 by the service provider are served by the PC2.0 DHCP server 54.

The DHCP server 50 further includes a terminal DHCP server 56 that provides IP address distribution service for the terminal device 20 to which the cable modem 10 provides VoIP service. In one embodiment, the several PC DHCP servers 52, 54 and the terminal DHCP server 56 may be disposed in one physical server or several physical servers.

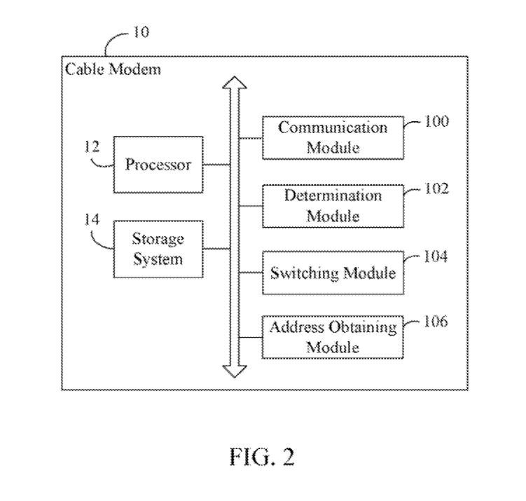

FIG. 2 is a schematic diagram of functional modules of one embodiment of a cable modem 10 of the present disclosure. In one embodiment, the cable modem 10 includes a processor 12, a storage system 14, a communication module 100, a determination module 102, a switching module 104, and an address obtaining module 106. Those modules may include one or more computerized instructions stored in the storage system 14 and executed by the processor 12.

The communication module 100 broadcasts a DHCP discover packet with the default PC protocol to the PC1.X DHCP server 52, the PC2.0 DHCP server 54, and the terminal DHCP server 56. The communication module 100 receives a DHCP offer packet from one of the PC1.X DHCP server 52, the PC2.0 DHCP server 54, and the terminal DHCP server 56. The determination module 102 determines if the received DHCP offer packet is compliant with the default PC protocol.

If the received DHCP offer packet is incompliant with the default PC protocol, then the switching module 104 changes the default PC protocol to another PC protocol which is different from the default PC protocol, such as changing PC1.X to PC2.0. The communication module 100 broadcasts another DHCP discover packet with the another PC protocol to the PC1.X DHCP server 52, the PC2.0 DHCP server 54, and the terminal DHCP server 56 to make the communication module 100 receive a compliant DHCP offer packet.

If the received DHCP offer packet is compliant with the default PC protocol, the address obtaining module 106 broadcasts a DHCP request packet to the PC1.X DHCP server 52, the PC2.0 DHCP server 54, and the terminal DHCP server 56. Then, the address obtaining module 106 receives a DHCP acknowledge (ACK) packet from the PC1.X DHCP server 52 or the PC2.0 DHCP server 54, and obtains the IP address distributed by the DHCP server 50 according to the DHCP ACK packet.

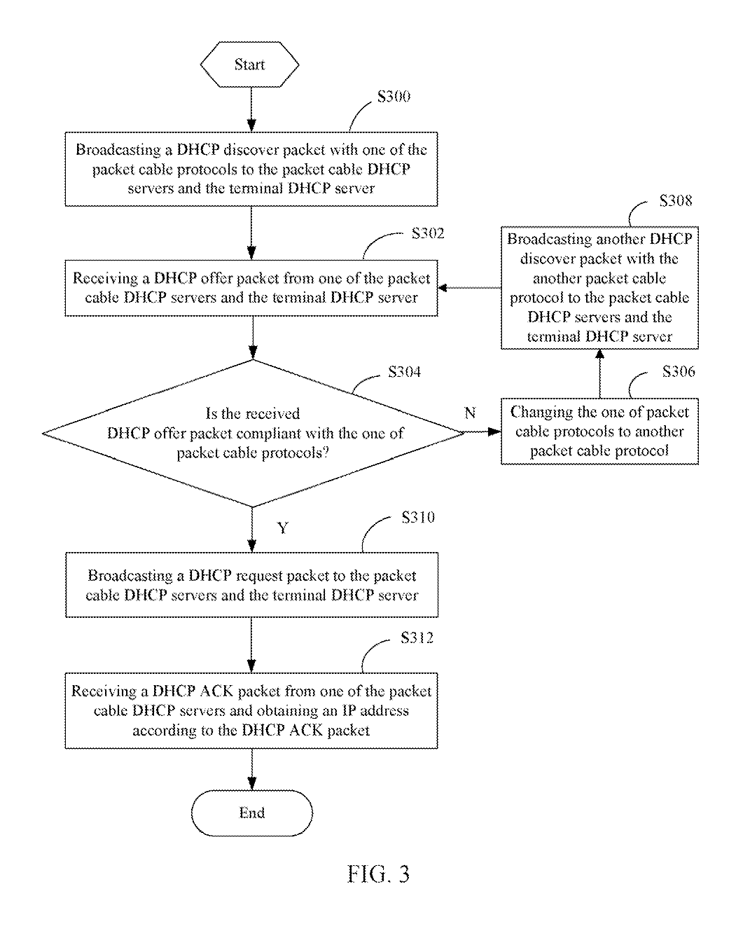

FIG. 3 is a flowchart of a method of supporting various PC protocol of one embodiment of the present disclosure. The flowchart is executed by the modules of FIG. 1. Depending on the embodiment, additional blocks may be added, others deleted, and the ordering of blocks may be changed while remaining well within the scope of the disclosure.

In block S300, the communication module 100 broadcasts a DHCP discover packet using the default PC protocol to the PC1.X DHCP server 52, the PC2.0 DHCP server 54, and the terminal DHCP server 56. In block S302, the communication module 100 receives a DHCP offer packet from one of the PC1.X DHCP server 52, the PC2.0 DHCP server 54, and the terminal DHCP server 56. In block S304, the determination module 102 determines if the received DHCP offer packet is compliant with the default PC protocol.

The DHCP offer packet that is compliant with the default PC protocol indicates that the DHCP offer packet includes a configuration file and an option 122, where the configuration file uses the default PC protocol. In detail, the DHCP specifies that the DHCP offer packet has a configuration file field and an option 122 field. The DHCP offer packet that includes the configuration file and the option 122 indicates the configuration file and the option 122 can be obtained from the configuration file field and the option 122 field in the DHCP offer packet. It should be understood that the option 122 field is a term of the art and is used by the PC1.X DHCP server 52 or the PC2.0 DHCP server 54 to transmit information to the cable modem 10.

If the default PC protocol of the cable modem 10 is different with that set for the cable modem 10 by the service provider, neither the PC1.X DHCP server 52 nor the PC2.0 DHCP server 54 will transmit the DHCP offer packet to the cable modem 10. In contrast, the terminal DHCP server 56 will transmit the DHCP offer packet to the cable modem 10 and the DHCP offer packet transmitted by the terminal DHCP server 56 does not include the configuration file and the option 122. At this time, the determination module 102 determines the received DHCP offer packet is incompliant with the default PC protocol.

If the received DHCP offer packet is incompliant with the default PC protocol, then in block S306, the switching module 104 changes the default PC protocol to another PC protocol. Then in block S308, the communication module 100 broadcasts another DHCP discover packet with the another PC protocol to the PC1.X DHCP server 52, the PC2.0 DHCP server 54, and the terminal DHCP server 56 to make the communication module 100 receive a compliant DHCP offer packet.

Therefore, after one time or several times switch of the PC protocols, the switching module 104 can switch the default PC protocol of the cable modem 10 to be same as that set for the cable modem 10 by the service provider. Then, the cable modem 10 can obtain the available IP address from the DHCP server 50 and provide VoIP service for the terminal device 20.

If the received DHCP offer packet is compliant with the default PC protocol, then in block S310, the address obtaining module 106 broadcasts a DHCP request packet to the PC1.X DHCP server 52, the PC2.0 DHCP server 54, and the terminal DHCP server 56. In block S312, the address obtaining module 106 receives a DHCP acknowledge (ACK) packet from the PC1.X DHCP server 52 or the PC2.0 DHCP server 54 and obtains the available IP address according to the DHCP ACK packet.

It is noted that the DHCP discover packet, the DHCP offer packet, the DHCP request packet, and the DHCP ACK packet are all specified by the DHCP. The detail description about them is omitted for simplicity.

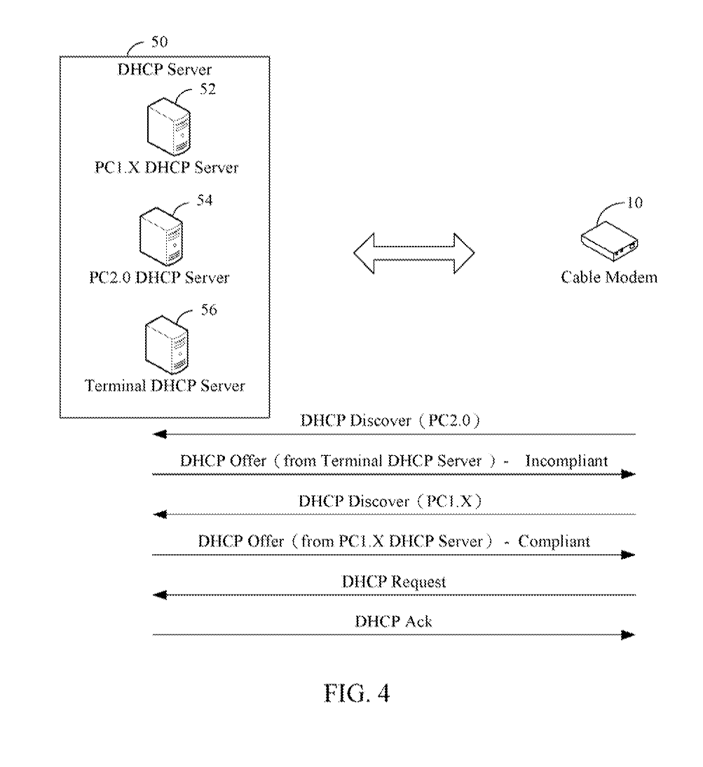

FIG. 4 is a schematic diagram of one embodiment of the method of FIG. 3 of the present disclosure. In the embodiment, the service provider sets PC1.X for the cable modem 10. That is, the service provider makes the PC1.X DHCP server 52 to provide IP address distribution service for the cable modem 10. The default PC protocol of the cable modem is PC2.0.

Firstly, the cable modem 10 broadcasts a PC2.0 DHCP discover packet to the DHCP server 50 to acquire an IP address for the cable modem 10. Then, any of the PC1.X DHCP server 52, the PC2.0 DHCP server 54, and the terminal DHCP server 56 receives the PC2.0 DHCP discover packet. The PC1.X DHCP server 52 does not response a DHCP offer packet because the PC2.0 DHCP discover packet uses PC2.0. The PC2.0 DHCP server 54 does not response a DHCP offer packet because the service provider does not make the PC2.0 DHCP server 54 to provide service for the cable modem 10. Therefore, the terminal DHCP server 56 responses a DHCP offer packet to the cable modem 10.

Secondly, the cable modem 10 receives the DHCP offer packet from the terminal DHCP server 56 and determines that the DHCP offer packet is incompliant with PC1.X. Then, the cable modem 10 changes the default PC protocol to PC1.X and broadcasts a PC1.X DHCP discover packet to the PC1.X DHCP server 52, the PC2.0 DHCP server 54, and the terminal DHCP server 56. As such, the PC1.X DHCP server 52 responses a PC1.X DHCP offer packet including a PC1.X configuration file and an option 122 to the cable modem 10.

Next, the cable modem 10 receives the PC1.X DHCP offer packet from the PC1.X DHCP server 52 and determines the PC1.X DHCP offer packet is compliant with PC1.X. Then, the cable modem 10 transmits a DHCP request packet to the PC1.X DHCP server 52, the PC2.0 DHCP server 54, and the terminal DHCP server 56 and receives a DHCP ACK packet from the PC1.X DHCP server 52 to obtain the IP address.

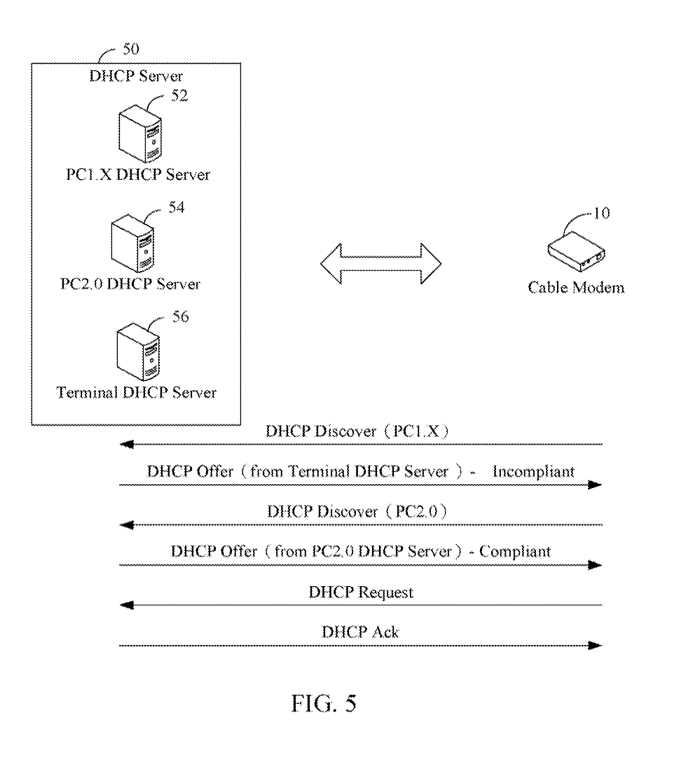

FIG. 5 is a schematic diagram of another embodiment of the method of FIG. 3 of the present disclosure. In the embodiment, the service provider sets PC2.0 for the cable modem 10. That is, the service provider makes the PC2.0 DHCP server 54 to provide IP address distribution service for the cable modem 10. The default PC protocol of the cable modem is PC1.X.

Firstly, the cable modem 10 broadcasts a PC1.X DHCP discover packet to the DHCP server 50 to acquire an IP address for the cable modem 10. Then, any of the PC1.X DHCP server 52, the PC2.0 DHCP server 54, and the terminal DHCP server 56 receives the PC1.X DHCP discover packet. The PC2.0 DHCP server 54 does not response a DHCP offer packet because the PC1.X DHCP discover packet uses PC1.X. The PC1.X DHCP server 52 does not response a DHCP offer packet because the service provider does not make the PC1.X DHCP server 52 to provide service for the cable modem 10. Therefore, the terminal DHCP server 56 responses a DHCP offer packet to the cable modem 10.

Secondary, the cable modem 10 receives the DHCP offer packet from the terminal DHCP server 56 and determines that the DHCP offer packet is incompliant with PC2.0. Then, the cable modem 10 changes the default PC protocol to PC2.0 and broadcasts a PC2.0 DHCP discover packet to the PC1.X DHCP server 52, the PC2.0 DHCP server 54, and the terminal DHCP server 56. As such, the PC2.0 DHCP server 54 responses a PC2.0 DHCP offer packet including a PC2.0 configuration file and an option 122 to the cable modem 10.

The cable modem 10 receives the PC2.0 DHCP offer packet from the PC2.0 DHCP server 54 and determines the PC2.0 DHCP offer packet is compliant with PC2.0. Then, the cable modem 10 transmits a DHCP request packet to the PC1.X DHCP server 52, the PC2.0 DHCP server 54, and the terminal DHCP server 56 and receives a DHCP ACK packet from the PC2.0 DHCP server 54 to obtain the IP address.

The cable modem 10 of the present disclosure determines if the default PC protocol of the cable modem is the same as the PC protocol set by the service provider for the cable modem 10 by determining if the DHCP offer packet is compliant with the default PC protocol. The cable modem 10 then selects one PC protocol for the cable modem 10 which is the same as that set by the service provider. Therefore, the cable modem 10 can support various PC protocol and can be wildly used in the VoIP network using the MGCP or the SIP.

While various embodiments of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A cable modem in communication with a plurality of packet cable dynamic host configuration protocol (DHCP) servers and a terminal DHCP server to support various packet cable protocols, each packet cable DHCP server corresponding to one of the packet cable protocols, the cable modem comprising a processor, a storage system, and one or more programs stored in the storage system and operable to be executed by the processor and comprising:
a communication module to broadcast a DHCP discover packet with one packet cable protocol to the packet cable DHCP servers and the terminal DHCP server, and to receive a DHCP offer packet from one of the packet cable DHCP servers and the terminal DHCP server;
a determination module to determine if the received DHCP offer packet is compliant with the one packet cable protocol; and
a switching module to change the one packet cable protocol to another packet cable protocol to make the communication module receive a compliant DHCP offer packet upon the condition that the received DHCP offer packet is incompliant with the one packet cable protocol.

2. The cable modem as claimed in claim 1, further comprising an address obtaining module to broadcast a DHCP request packet to the packet cable DHCP servers and the terminal DHCP server, to receive a DHCP acknowledge (ACK) packet from one of the packet cable DHCP servers, and to obtain an IP address according to the DHCP ACK packet upon the condition that the received DHCP offer packet is compliant with the one packet cable protocols.

3. The cable modem as claimed in claim 2, wherein the DHCP offer packet that is compliant with the one of the packet cable protocols indicates that the DHCP offer packet includes a configuration file and an option 122, and the configuration file uses the one of the packet cable protocols.

4. The cable modem as claimed in claim 1, wherein the various packet cable protocols comprise packet cable 1.X and packet cable 2.0, and the packet cable 1.X indicates packet cable 1.0 or packet cable 1.5.

5. A method of supporting various packet cable protocols of a cable modem, the cable modem in communication with a plurality of packet cable DHCP servers and a terminal DHCP server to support various packet cable protocols, each packet cable DHCP server corresponding to one of the packet cable protocols, the method comprising:
broadcasting a DHCP discover packet with one of the packet cable protocols to the packet cable DHCP servers and the terminal DHCP server;
receiving a DHCP offer packet from one of the packet cable DHCP servers and the terminal DHCP server;
determining if the received DHCP offer packet is compliant with the one of packet cable protocols;
changing the one of packet cable protocols to another packet cable protocol if the received DHCP offer packet is incompliant with the one of packet cable protocols; and
broadcasting another DHCP discover packet with the another packet cable protocol to the packet cable DHCP servers and the terminal DHCP server to receive a compliant DHCP offer packet.

6. The method as claimed in claim 5, further comprising:
broadcasting a DHCP request packet to the packet cable DHCP servers and the terminal DHCP server if the received DHCP offer packet is compliant with the one of packet cable protocols; and
receiving a DHCP ACK packet from one of the packet cable DHCP servers and obtaining an IP address according to the DHCP ACK packet.

7. The method as claimed in claim 6, wherein the DHCP offer packet that is compliant with the one of packet cable protocols indicates that the DHCP offer packet includes a configuration file and an option 122, and the configuration file uses the one of packet cable protocols.

8. The method as claimed in claim 5, wherein the various packet cable protocols comprise packet cable 1.X and packet cable 2.0, and the packet cable 1.X indicates packet cable 1.0 or packet cable 1.5.
